(19) United States
(12) Patent Application Publication
(10) Pub. No.: US 2026/0136120 A1
(43) Pub. Date: May 14, 2026

(54) Headphone Headband with Integral Slide Lock

(71) Applicant: Bose Corporation, Framingham, MA (US)

(72) Inventors: Allen Timothy Graff, Sutton, MA (US); Zhen Xu, Milford, MA (US)

(21) Appl. No.: 18/940,945

(22) Filed: Nov. 8, 2024

(51) Int. Cl. H04R 1/10

(52) U.S. Cl. CPC H04R 1/10

(57) ABSTRACT

Aspects include headphones and headbands for headphones. In certain cases, a headphone headband includes: a cushion assembly having: a cushion frame, and a top cap coupled with the cushion frame; a slider telescopically coupled to the cushion assembly, the slider comprising a proximal end disposed within the cushion assembly and a distal end extending outward from the cushion assembly, where the cushion frame and the top cap interface to provide an integral slide lock, and collectively define a channel for guiding the slider; an earphone; and a yoke coupling the earphone to the slider.

### BACKGROUND

The disclosure relates generally to wearable audio devices. More particularly, the disclosure relates to headphones and related headbands.

### SUMMARY

Various implementations are directed to headphones and related headbands for headphones. In certain cases, a headphone headband includes an integral slide lock.

In particular cases, a headphone headband includes: a cushion assembly having: a cushion frame, and a top cap coupled with the cushion frame; a slider telescopically coupled to the cushion assembly, the slider comprising a proximal end disposed within the cushion assembly and a distal end extending outward from the cushion assembly, where the cushion frame and the top cap interface to provide an integral slide lock, and collectively define a channel for guiding the slider; an earphone; and a yoke coupling the earphone to the slider.

All examples and features mentioned below can be combined in any technically possible way.

In certain cases, the integral slide lock is defined by a plurality of protrusions in the top cap that are received in a plurality of recesses in the cushion frame.

In some aspects, the protrusions extend outward from an interior wall in the top cap, and the recesses in the cushion frame are approximately L-shaped.

In particular implementations, the integral slide lock prevents separation of the cushion frame and the top cap while the slider moves relative to the cushion assembly.

In certain cases, the cushion frame further includes at least one projection interfacing with an interior wall of the top cap. In some examples, the projection(s) can include a taper on one side, for example, on a side opposing an interface with the interior wall.

In some aspects, the at least one projection includes a plurality of projections disposed along an axis of the channel.

In certain cases, the at least one projection substantially prevents deflection of the interior wall to maintain the coupling between the top cap and the cushion frame.

In particular aspects, a majority of the channel is located in the cushion frame. In some cases, the channel extends along at least a portion of the arc of the headband.

In certain implementations, the channel includes a groove sized to receive a protuberance in the slider.

In some cases, the protuberance extends inward from a main body of the slider.

In particular cases, the protuberance includes at least one friction member that provides sliding friction during movement of the slider relative to the cushion assembly. In some examples, the friction member includes silicone or another frictional material.

In certain aspects, the protuberance further includes a pocket housing the at least one friction member.

In some cases, the headband further includes at least one bumper at a distal end of the slider. The bumper(s) can be referred to as protrusions or bumps in some examples.

In particular aspects, the at least one bumper provides an offset between an outer surface of the slider and an inner surface of the cushion assembly. The offset can prevent cosmetic (e.g., outwardly facing) surfaces of the slider from rubbing against the cushion frame or the top cap.

In some cases, the integral slide lock provides approximately an entirety of a locking force required to retain the slider in the channel.

In particular aspects, the headband further includes a stopper for limiting movement of the proximal end of the slider within the channel. In other cases, the stopper is referred to as a latch. In other, optional cases, the latch includes a cam surface. In some cases, the stopper is formed of a material having surface resilience when contacted by oils, perspiration, etc. In some examples, the material includes high-density polyethylene (HDPE) or an equivalent, which can mitigate changes in material properties when contacted by skin oils, perspiration, etc.

In certain cases, the stopper provides a tactile feel when interfacing with the cushion frame and the top cap.

In particular implementations, the headband further includes a set of bumpers in the channel for providing consistency in friction feel during movement of the slider relative to the cushion assembly.

In some aspects, the headband further includes a spring including a bend located in the cushion assembly, the spring terminating proximate to an opening in the cushion assembly.

In certain implementations, the slider has a hollow interior portion extending along a length thereof.

In particular cases, the headband further includes an electro-acoustic transducer housed in the earphone for providing an audio output.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a perspective view of one example headphone according to various implementations.

FIG. 2 is a side perspective of the headphone of FIG. 1 according to various implementations.

FIG. 3 is a cross-sectional perspective of a portion of a headband in a headphone according to various implementations.

FIG. 4 is a cross-sectional perspective of the headband of FIG. 3 with the addition of a slider, according to various implementations.

FIG. 5 is a cross-sectional perspective of a portion of a headband according to various implementations.

FIG. 6 is a perspective view of sections of a headband according to various additional implementations.

FIG. 7 is an additional perspective view of a section of the headband of FIG. 6 according to various implementations.

FIG. 8 is a sectional perspective view of the headband of FIGS. 6 and 7.

FIG. 9 is a partial sectional view of the headband of FIGS. 6-8.

FIG. 10 shows additional features in the sectional view of FIG. 9.

FIG. 11 is a cross-sectional end view of the headband of FIGS. 6-10.

It is noted that the drawings of the various implementations are not necessarily to scale.

The drawings are intended to depict only typical aspects of the disclosure, and therefore should not be considered as limiting the scope of the implementations. In the drawings, like numbering represents like elements between the drawings.

### DETAILED DESCRIPTION

Various disclosed implementations include headphone headbands that include an integral slide lock for the slider. These implementations may reduce manufacturing costs and/or complexity relative to conventional headphone headbands, among other benefits.

Commonly labeled components in the FIGURES are considered to be substantially equivalent components for the purposes of illustration, and redundant discussion of those components is omitted for clarity.

### Headphone

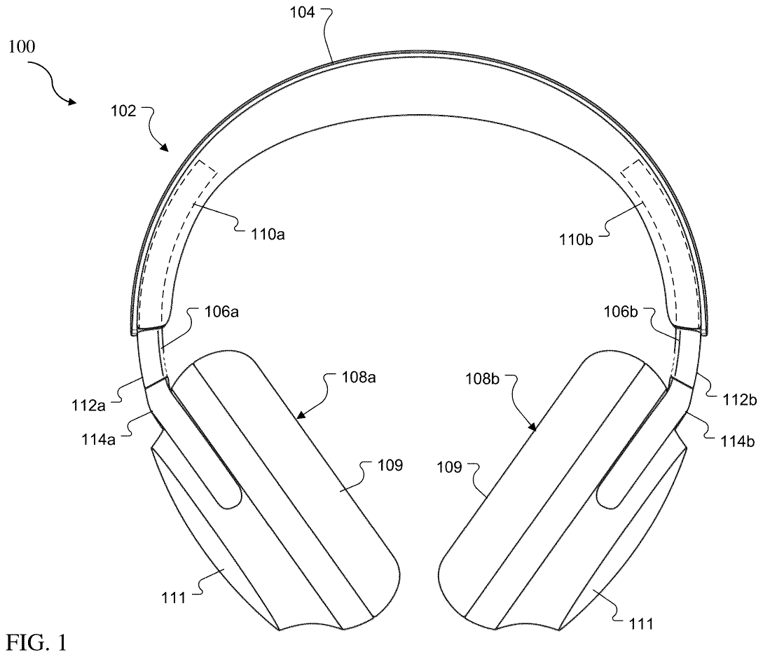

FIG. 1 shows headphones 100 according to various implementations. Headphones 100 include headband 102 which includes flat tubular cushion assembly 104 that is constructed and arranged to be placed over the crown of the head of a person. In some examples, tubular sliders 106a and 106b (collectively “106”) support earphones 108a and 108b (collectively “108”). The sliders engage with cushion assembly 104 in a manner which allows the sliders to be moved in and out of the cushion assembly to adjust the overall length of the headband so that they headphones can sit comfortably on, in or over the ears of the wearer. This overall arrangement of headphones is known in the art. Also, in some cases a microphone (not shown) can be included so that the headphones can be used as a headset. Further, some headphones or headsets include only one earphone, in which case there may be only one slider.

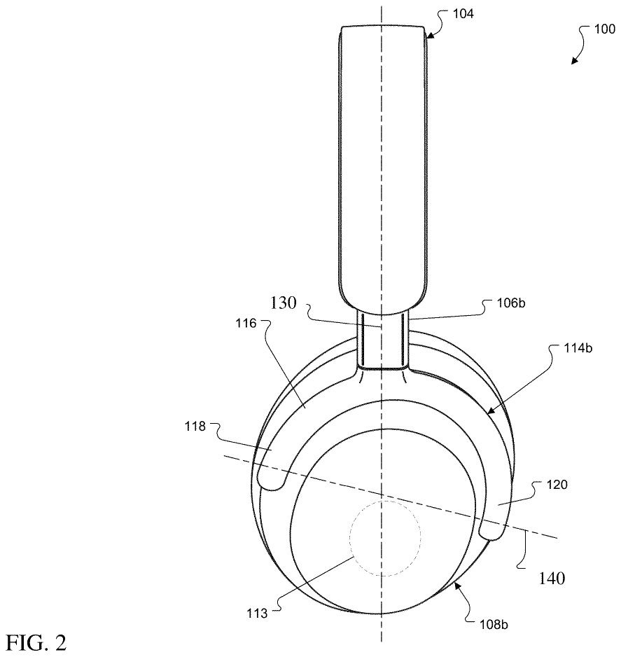

In certain cases, cushion assembly 104 is generally tubular. This arrangement allows the sliders to be received within the volume on the inside of the tube and also allows wiring to pass along the length of the cushion assembly. Alternative shapes of cushion assembly 104 are also possible. Sliders 106a and 106b are located in part in this interior volume of the cushion assembly. Each slider has a proximal end 110a, 110b located in the cushion assembly (e.g., end 110a of slider 106a) and a distal end 112a, 112b (e.g., end 112a of slider 106a). Coupling members 114a and 114b (collectively “114”) are pivotably coupled to sliders 106. The coupling members each carry an earphone 108 (aka “earpiece”) at their far ends. Earphones 108a and 108b are shown in FIG. 1. Each of the earphones 108 includes an ear cushion 109 and an earcup 111 that supports an electro-acoustic transducer 113 (FIG. 2) .

In some non-limiting examples, the sliders each generally hollow tubes with a generally flat exterior surface that lies closest to the head. The sliders may have an oblong cross-sectional shape, such as a stadium (aka “racetrack”), oval or elliptical shape. Various additional shapes are also possible according to implementations.

An example of a coupling member 114b is shown in more detail in FIG. 2. FIG. 2 shows a left coupling member 114b in headphones 100. A mirror-image of the design would be used for the right coupling member 114a. Coupling member 114b includes a yoke 116 with legs 118 and 120 that carry earphone 108. Earphone coupling members (not shown) are coupled to earphone 108b and allow it to rotate about axis 130. Also, coupling member 114b is engaged with slider 106b in a manner to allow the yoke to pivot about axis 140.

Additional features of the headphones 100, such as the conductive cable interconnecting earphones 108a and 108b are not illustrated but are known in the art, for example, as described in US Patent Application Ser. No. 17/881,964 (Headphones, published as US PG Publication 2024/0048887), filed Aug. 5, 2022, the entire contents of which are hereby incorporated by reference.

### Headband

The following provides further description of an example headband for headphones, e.g., headphones 100. In some cases, the headband or portions thereof can be substituted for headband 102 in headphones 100 (FIGS. 1 and 2). Further, similarly labeled features in the drawings can be considered to be substantially similar components.

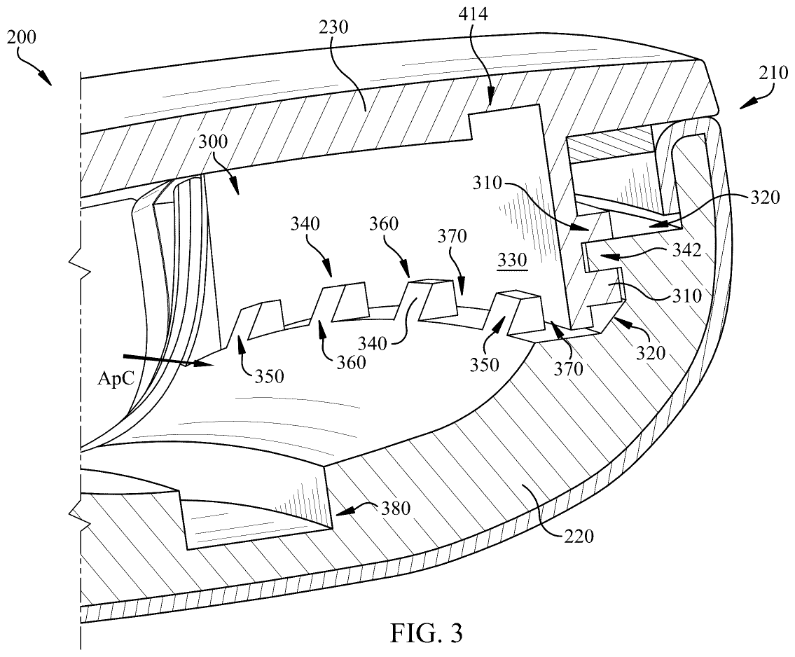

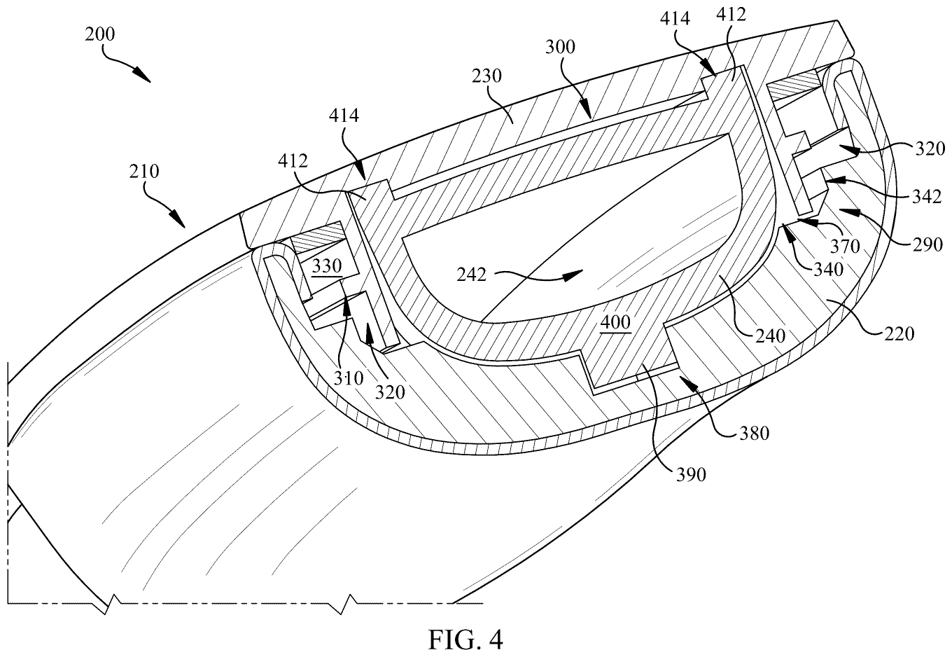

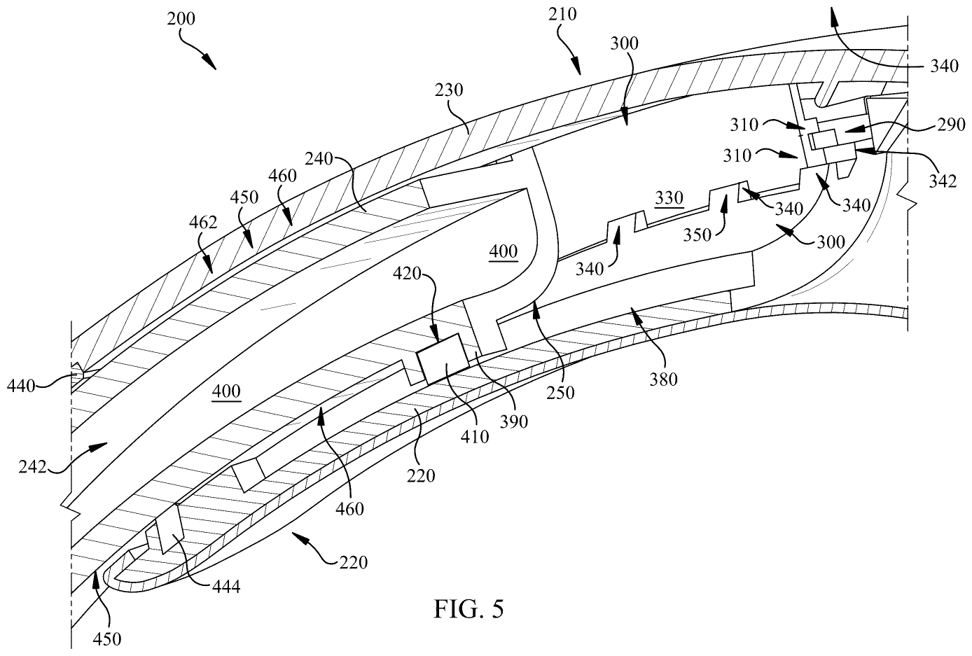

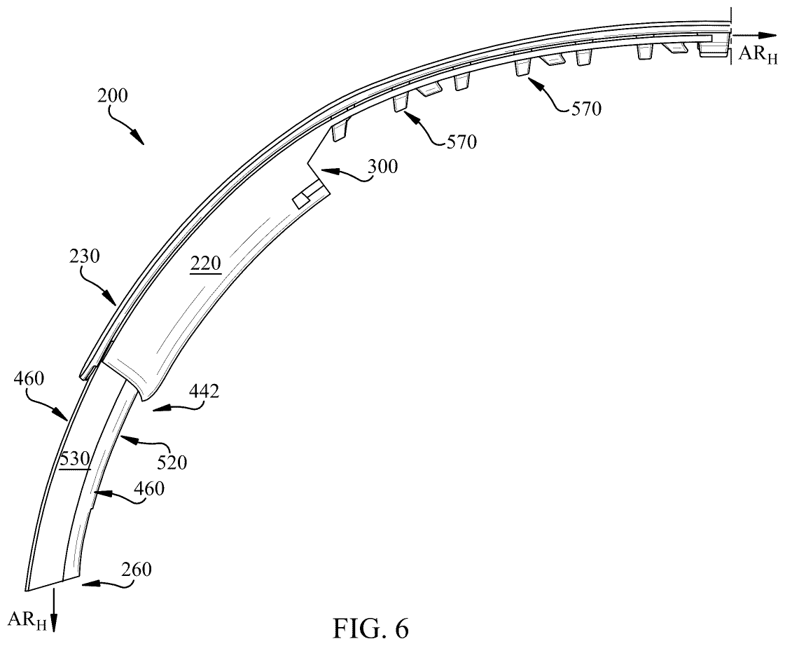

Turning to FIGS. 3-5, a headphone headband 200 is illustrated including: a cushion assembly 210 having a cushion frame 220 and a top cap 230 coupled with the cushion frame 220. The headband 200 further includes a slider 240 (FIGS. 4, 5) telescopically coupled to the cushion assembly 210. In certain cases, e.g., as depicted in FIGS. 4 and 5, the slider 240 can include a substantially hollow interior portion 242 extending along a length thereof. The hollow interior portion 242 can contribute to reduced weight, material, and cost in forming the slider 240. As illustrated, the slider 240 includes a proximal end 250 disposed within the cushion assembly 210, and a distal end 260 (e.g., FIG. 6) extending outward from the cushion assembly 210. It is understood that distal end 260 of slider 240 can be configured to couple with yoke 116 in a headphone 100 such as illustrated in FIGS. 1 and 2, e.g., coupling the earphone 108 to the slider 240.

In particular implementations, e.g., as depicted in FIGS. 3-5, the cushion frame 220 and the top cap 230 interface to provide an integral slide lock 290, and collectively define a channel 300 for guiding the slider 240. In certain cases, the integral slide lock 290 is defined by a plurality of protrusions 310 in the top cap 230 that are received in a plurality of recesses 320 in the cushion frame 220. In some examples, the protrusions 310 extend outward from an interior wall 330 in the top cap 230. In one example, the recesses 320 are approximately L-shaped. However, recesses 320 can be shaped in any configuration suitable to receive protrusions 310.

It is understood that protrusions 310 in top cap 230 and recesses 320 in cushion frame 220 could be reversed, such that top cap 230 includes recesses and cushion frame 220 includes protrusions in other implementations. Further, relationships between corresponding or complementary features such as protrusions/tabs and recesses/slots can also be reversed wherever practical without deviating from the disclosed implementations.

Returning to FIGS. 3-5, in particular implementations, the integral slide lock 290 prevents separation of the cushion frame 220 and the top cap 230 while the slider 240 moves relative to the cushion assembly 210. In some example cases, the integral slide lock 290 provides approximately an entirety of a locking force required to retain the slider 240 in the channel 300.

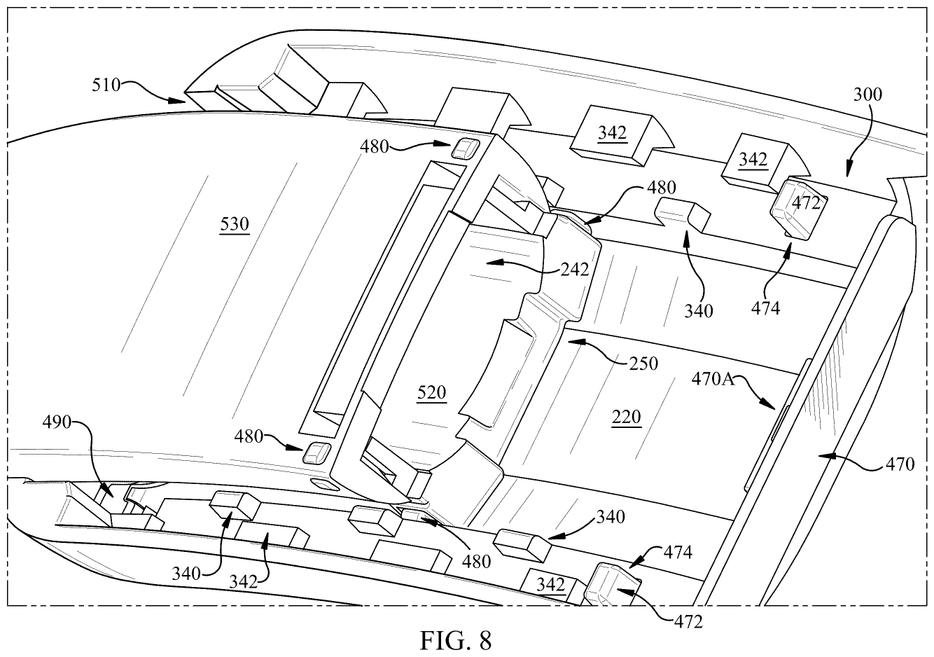

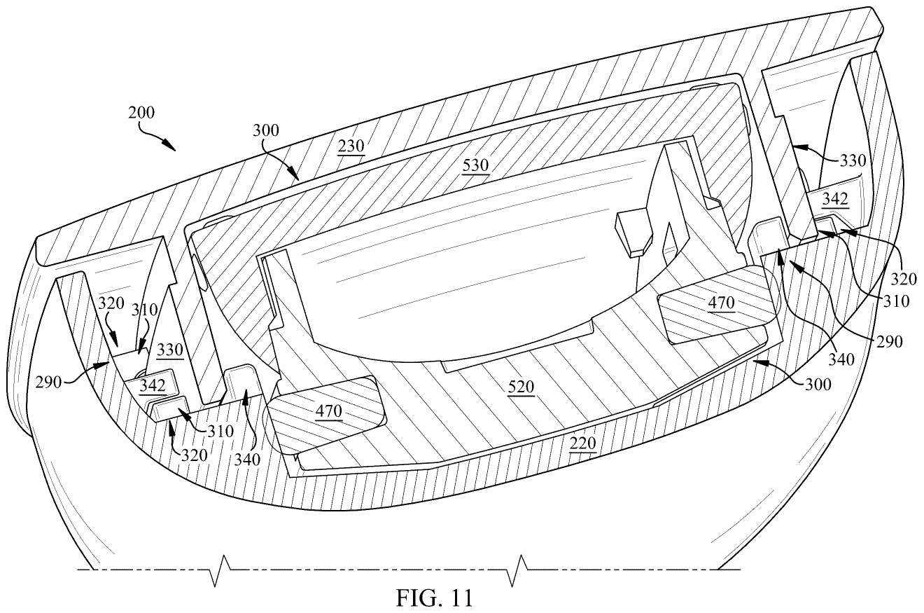

In some examples, e.g., as depicted in FIGS. 3 and 5 (also, FIGS. 8 and 11) the cushion frame 220 further includes at least one projection 340 interfacing with interior wall 330 of the top cap 230. In some examples, the projection(s) 340 (in cushion frame 220) can include a taper 350 on one side, for example, on a side 360 opposing an interface 370 with the interior wall 330. In some aspects, a plurality of projections 340 (in cushion frame 220) are disposed along an axis (e.g., primary axis (Aₚc) of the channel 300. The projection(s) 340 can substantially prevent deflection of the interior wall 330 to maintain the coupling between the top cap 230 and the cushion frame 220 in various implementations. That is, projections 340 can help prevent buckling of interior wall 330 to aid in maintaining coupling between top cap 230 and cushion frame 220. In additional implementations, supports 342 in the cushion frame 220 are also present on an outer side of the interior wall 330 to aid in stabilizing interior wall 330. In some cases, e.g., as illustrated in one implementation of a headband 200 in FIG. 3 and in another implementation of headband 200 in FIG. 11, supports 342 align with or otherwise complement the shape of protrusions 310. Supports 342 can be located adjacent to interior wall 330 in various implementations, e.g., with nominal clearance, to control buckling of the wall 330.

As illustrated in FIGS. 5 and 6, in some aspects a majority of the channel 300 is located in the cushion frame 220. In particular cases, more than half of the channel 300 is located in the cushion frame 220. In further cases, a significant majority (e.g., two-thirds, three-quarters, eight-tenths, etc.) of the channel 300 is located in the cushion frame 220. In some cases, the channel 300 extends along at least a portion of the arc (AR_{H}) of the headband 200 (FIG. 6). In certain implementations, e.g., as shown in FIGS. 3-5, with particular reference to FIG. 5, the channel 300 includes a groove 380 sized to receive a protuberance 390 in the slider 240. The protuberance 390 can extend inward from a main body 400 of the slider 240, and in some examples, includes at least one friction member 410 that provides sliding friction during movement of the slider 240 relative to the cushion assembly 210. In some examples, the friction member 410 includes silicone or another frictional material. The protuberance 390 can further include a pocket 420 housing the at least one friction member 410 in some implementations. In some non-limiting optional implementations illustrated in FIGS. 3 and 4, the slider 240 also includes a set of ribs 412 extending from the main body 400. The ribs 412 can mate with corresponding grooves (or slots) 414 in the top cap 230.

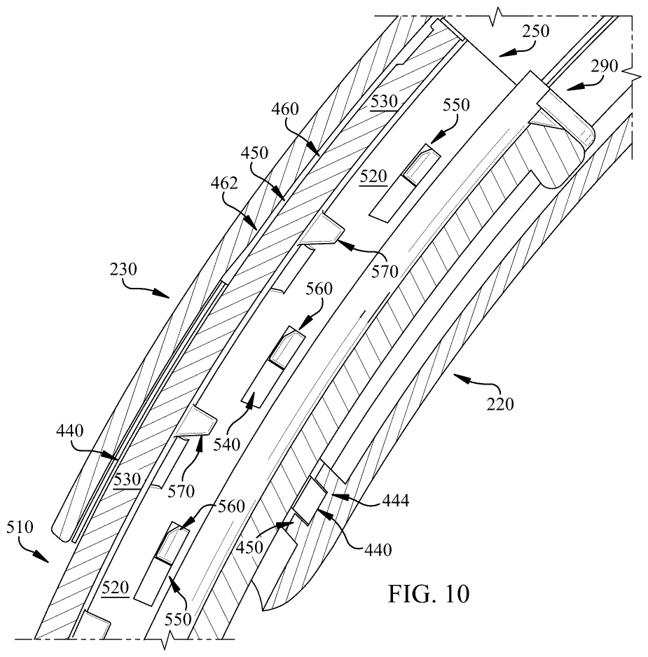

In further implementations, e.g., as illustrated in FIGS. 5, 6, and 10, the headband 200 further includes at least one bumper 440 proximate an end 442 of the cushion assembly 210, e.g., at least one bumper 440 on the cushion frame 220 and/or the top cap 230. In some cases, as shown in FIG. 5, the bumper 440 can sit in a slot 444 in the cushion frame 220. The bumper(s) 440 can be referred to as protrusions or bumps in some examples. Bumper(s) 440 can provide an offset 450 between an outer surface 460 of the slider 240 and an inner surface 462 of the cushion assembly 210. The offset 450 can prevent cosmetic (e.g., outwardly facing) surfaces of the slider 240, e.g., outer surface 460, from rubbing against the cushion frame 220 or the top cap 230.

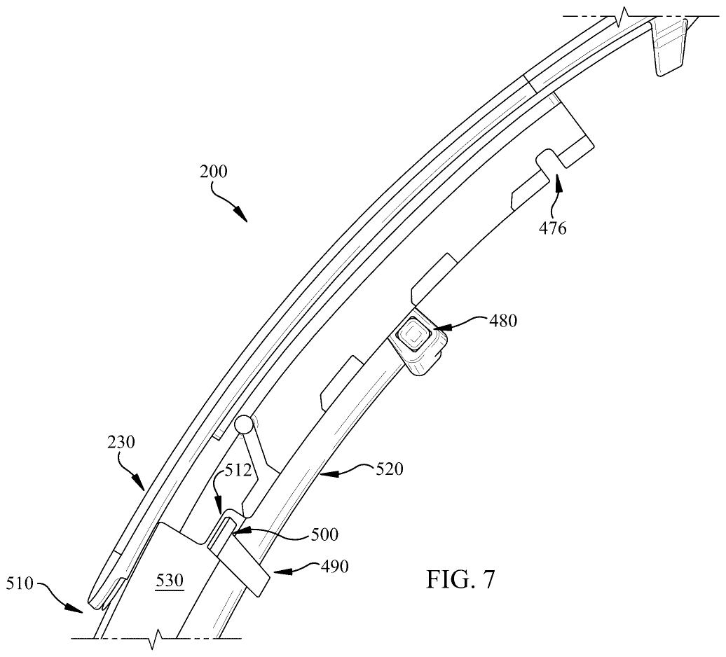

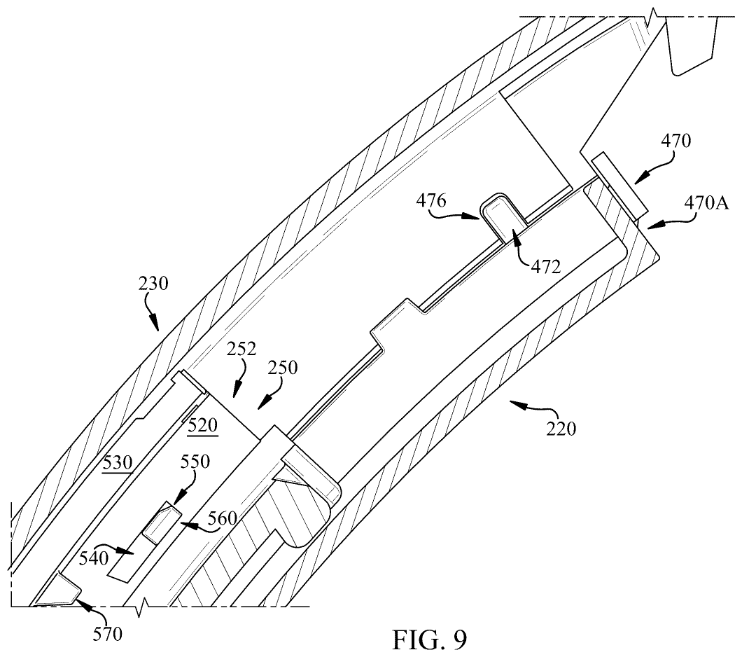

In particular aspects, the headband 200 further includes a stopper 470 (FIGS. 8, 9, 11) for limiting movement of the proximal end 250 of the slider 240 within the channel 300. In other cases, the stopper 470 is referred to as a latch. In other, optional cases, the latch includes a cam surface. In some cases, the stopper 470 is formed of a material having surface resilience when contacted by oils, perspiration, etc. In some examples, the material includes high-density polyethylene (HDPE) or an equivalent, which can mitigate changes in material properties when contacted by skin oils, perspiration, etc. During use of the headband 200, stopper 470 can provides a tactile feel when interfacing with the cushion frame 220 and the top cap 230. FIGS. 8 and 9 illustrate a stopper 470 used to limit movement of the distal end 250 of the slider 240. In various implementations, the stopper 470 is retained in the cushion frame 220 via retention tabs 472 that mate with corresponding slots 474. The slots 474 and tabs 472 can be positioned axially beyond the last projection 342 and support 340 along the cushion frame 220. Further, tabs 472 can interface with openings 476 in the top cap 230 in some cases (FIGS. 7, 9), providing additional coupling of the top cap 230 and the cushion frame 220. Additionally, engagement of tabs 472 in openings 476 can prevent the cushion frame 220 from sliding axially back off the top cap 230. These functions can also be accomplished with couplers (e.g., snaps), not shown, that engage when the cushion frame 220 has slid into its intended assembled position. In addition to stopper 470 shown and described relative to FIGS. 8, 9, and 11, FIG. 9 also illustrates an additional stopper 470A that can be configured to limit movement of the proximal end 350 of the slider 240 within the channel 300 in some optional implementations. In some cases, this stopper 470A can be part of (e.g., a wall of) the cushion frame 220.

In still further implementations, as illustrated in the example configuration in FIGS. 7 and 8, the headband 200 can include a set of bumpers 480 in the channel 300 for providing consistency in friction feel during movement of the slider 240 relative to the cushion assembly 210. For example, the bumpers 480 in the channel 300 can provide a consistent feeling of friction for the user of the headband 200 as the slider 240 is moved relative to the cushion assembly 210.

In still further implementations, as shown in FIG. 7, headband 200 can include a spring 490 including a bend 500 located in the cushion assembly 210. In some cases, the spring 490 terminates proximate to an opening 510 in the cushion assembly 210. The spring 490 can interface with a recess 512 (e.g., notch, cut-out, or corner) in the top cap 230 according to various implementations.

In certain implementations, the slider 240 is formed of a single component, e.g., a unitary member and/or a substantially consistent material throughout. In further implementations, the slider 240 is formed of multiple components. For example, FIGS. 3-5 illustrate a slider 240 formed as a unitary member, while the slider 240 shown in FIGS. 6-9 includes two distinct components, e.g., a lower section 520 and an upper section 530. These sections 520, 530 can be coupled via any conventional mechanism, e.g., via male/female connectors 540, 550, such as tabs and corresponding slots. In some cases, the male-female connectors 540, 550 can be configured to slide to lock/unlock, e.g., such that a male connector 540 includes a tab 560 for engaging a female connector 550 in one position and enabling disengagement in another position. Additional connectors 570 can also be used to connect sections 520, 530, e.g., via sliding, interlocking tabs and corresponding slots. Further, additional snap features and/or connectors similar to connectors 540, 550, and/or 570 can be used to prevent movement (e.g., axial movement) of lower section 520 relative to upper section 530.

In any case, as noted herein, the headbands disclosed according to various implementations can reduce manufacturing costs and/or complexity relative to conventional headphone headbands. For example, the headbands can minimize (or eliminate) the need for separate fasteners to maintain a slide lock (or guide) for a headband slider. The integral slide lock can also enhance the useful life of the headband by reducing failures in moving components. Additionally, relative to certain conventional headbands, the headbands disclosed according to various implementations can be visually appealing as having fewer visible fasteners (or altogether eliminating such fasteners). Even further, the headbands disclosed according to various implementations can be beneficially lighter, and in some cases, smaller than conventional headbands due in part to reduction in fasteners.

The systems and methods disclosed herein may include or operate in, in some examples, headsets, headphones, hearing aids, or other personal audio devices, as well as acoustic noise reduction systems that may be applied to home, office, or automotive environments. Throughout this disclosure the terms “headset,” “headphone,” “earphone,” and “headphone set” are used interchangeably, and no distinction is meant to be made by the use of one term over another unless the context clearly indicates otherwise. Additionally, aspects and examples in accord with those disclosed herein are applicable to various form factors, such as in-ear transducers or earbuds and on-ear or over-ear headphones, and others.

Examples disclosed may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

For various components described herein, a designation of “a” or “b” in the reference numeral may be used to indicate “right” or “left” versions of one or more components. When no such designation is included, the description is without regard to the right or left and is equally applicable to either of the right or left, which is generally the case for the various examples described herein. Additionally, aspects and examples described herein are equally applicable to monaural or single-sided personal acoustic devices and do not necessarily require both of a right and left side.

Examples of the headphones described herein are not limited in application to the details of construction and the arrangement of components set forth in the following description or illustrated in the accompanying drawings. The headphones are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

The term “approximately” as used with respect to values herein can allot for a nominal variation from absolute values, e.g., of several percent or less. Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

We claim:

1. A headphone headband, comprising:
a cushion assembly having: a cushion frame, and a top cap coupled with the cushion frame;
a slider telescopically coupled to the cushion assembly, the slider comprising a proximal end disposed within the cushion assembly and a distal end extending outward from the cushion assembly,
wherein the cushion frame and the top cap interface to provide an integral slide lock, and collectively define a channel for guiding the slider;
an earphone; and
a yoke coupling the earphone to the slider.

2. The headband of claim 1, wherein the integral slide lock is defined by a plurality of protrusions in the top cap that are received in a plurality of recesses in the cushion frame.

3. The headband of claim 2, wherein the protrusions extend outward from an interior wall in the top cap, and wherein the recesses in the cushion frame are approximately L-shaped.

4. The headband of claim 1, wherein the integral slide lock prevents separation of the cushion frame and the top cap while the slider moves relative to the cushion assembly.

5. The headband of claim 1, wherein the cushion frame further includes at least one projection interfacing with an interior wall of the top cap.

6. The headband of claim 5, wherein the at least one projection includes a plurality of projections disposed along an axis of the channel.

7. The headband of claim 5, wherein the at least one projection substantially prevents deflection of the interior wall to maintain the coupling between the top cap and the cushion frame.

8. The headband of claim 1, wherein a majority of the channel is located in the cushion frame.

9. The headband of claim 1, wherein the channel includes a groove sized to receive a protuberance in the slider.

10. The headband of claim 9, wherein the protuberance extends inward from a main body of the slider.

11. The headband of claim 9, wherein the protuberance includes at least one friction member that provides sliding friction during movement of the slider relative to the cushion assembly.

12. The headband of claim 11, wherein the protuberance further includes a pocket housing the at least one friction member.

13. The headband of claim 1, further comprising at least one bumper at a distal end of the slider.

14. The headband of claim 13, wherein the at least one bumper provides an offset between an outer surface of the slider and an inner surface of the cushion assembly.

15. The headband of claim 1, wherein the integral slide lock provides approximately an entirety of a locking force required to retain the slider in the channel.

16. The headband of claim 1, further comprising a stopper for limiting movement of the proximal end of the slider within the channel, wherein the stopper provides a tactile feel when interfacing with the cushion frame and the top cap.

17. The headband of claim 1, further comprising a set of bumpers in the channel for providing consistency in friction feel during movement of the slider relative to the cushion assembly.

18. The headband of claim 1, further comprising a spring including a bend located in the cushion assembly, the spring terminating proximate to an opening in the cushion assembly.

19. The headband of claim 1, wherein the slider has a hollow interior portion extending along a length thereof.

20. The headband of claim 1, further comprising an electro-acoustic transducer housed in the earphone for providing an audio output.
